(19) United States
(12) Patent Application Publication
(10) Pub. No.: US 2026/0101102 A1
(43) Pub. Date: Apr. 9, 2026

(54) SOLID-STATE IMAGING DEVICE, ELECTRONIC APPARATUS, AND PROGRAM

(71) Applicant: SONY SEMICONDUCTOR SOLUTIONS CORPORATION, KANAGAWA (JP)

(72) Inventors: RYOHEI KAZAMA, KANAGAWA (JP); KAZUYUKI WAKAYAMA, KANAGAWA (JP); TAKASHI KUSAKARI, KANAGAWA (JP)

(21) Appl. No.: 19/112,974

(22) PCT Filed: Sep. 12, 2023
(86) PCT No.: PCT/JP2023/033250

§ 371 Date: Mar. 19, 2025

(30) Foreign Application Priority Data
Sep. 26, 2022 (JP) 2022-152901

(51) Int. Cl. H04N 23/611; G01S 17/86; G01S 17/894; G06V 40/16; H04N 23/56; H04N 23/63

(52) U.S. Cl. CPC H04N 23/611; G01S 17/86; G01S 17/894; G06V 40/172; H04N 23/56; H04N 23/63

(57) ABSTRACT

Authentication accuracy is improved. A solid-state imaging device includes a light source, a first light receiving region, and a second light receiving region. The light source is provided on an opposite side of a display surface of a display, and emits light in an infrared light band via the display. The first light receiving region is provided on an opposite side of the display surface of the display, and includes a pixel that receives light in a visible light band and a pixel that receives at least light in an infrared light band emitted from the light source. The second light receiving region is provided on an opposite side of the display surface of the display, and includes a pixel that receives at least light in an infrared light band emitted from the light source.

### TECHNICAL FIELD

The present disclosure relates to a solid-state imaging device, an electronic apparatus, and a program.

### BACKGROUND ART

The realization of a face authentication function has become a widely used technology. In realization of processing requiring various types of security in a mobile terminal, improvement of accuracy of the face authentication function in the mobile terminal is desired. As a face authentication method, there are a method of acquiring both a distance image and a two-dimensional image by a depth camera, a method of acquiring a distance image by a depth camera and acquiring a two-dimensional image by an RGB camera, and a method of acquiring a two-dimensional image and parallax by using two RGB cameras and acquiring a distance image from the parallax.

In the method using the RGB camera, there are problems that it is difficult to acquire a two-dimensional image in a dark place, and the number of cameras increases, which causes design restriction in a mobile terminal.

On the other hand, generally, there is a difference between the distance information required in the face authentication technology and the resolution of the two-dimensional image, and the two-dimensional image requires a high-resolution image. At this time, in the case of the format in which both images are acquired by the depth camera, there is a problem that it is necessary to acquire a depth having a resolution higher than necessary in order to maintain the resolution of the two-dimensional image. Furthermore, in a mobile terminal, it is necessary to make a hole for a camera on a display side only for face authentication, which is also not desirable.

### CITATION LIST

### Patent Document

Patent Document 1: US 2021/0406350 A

### SUMMARY OF THE INVENTION

### Problems to be Solved by the Invention

Therefore, the present disclosure provides a solid-state imaging device that improves authentication accuracy.

### Solutions to Problems

According to an embodiment, a solid-state imaging device includes a light source, a first light receiving region, and a second light receiving region. The light source is provided on an opposite side of a display surface of a display, and emits light in an infrared light band via the display. The first light receiving region is provided on an opposite side of the display surface of the display, and includes a pixel that receives light in a visible light band and a pixel that receives at least light in an infrared light band emitted from the light source. The second light receiving region is provided on an opposite side of the display surface of the display, and includes a pixel that receives at least light in an infrared light band emitted from the light source.

The solid-state imaging device may further include: a first processing circuit that generates an infrared light image based on intensity of infrared light received in the first light receiving region; and a second processing circuit that generates a depth image based on intensity of infrared light received in the second light receiving region.

The solid-state imaging device may further include a third processing circuit that determines whether a subject is an authentication target on the basis of the depth image, and executes authentication processing using at least the infrared light image in a case where it is determined that the subject is the authentication target.

The first light receiving region may include a dual-bandpass filter having transmission characteristics in two bands of a visible light band and an infrared light band between the first light receiving region and the display surface of the display.

The second light receiving region may include a bandpass filter having transmission characteristics in an infrared light band between the second light receiving region and the display surface of the display.

The light source may include a surface light source.

The light source may include a surface light source that receives light in the first light receiving region, and a point light source that receives light in the second light receiving region.

The solid-state imaging device may further include a light shielding wall between the light source, and the first light receiving region and the second light receiving region on an opposite side of the display surface of the display.

The solid-state imaging device may further include a control circuit that performs drive control of the first light receiving region, drive control of the second light receiving region, and control of the light source. The control circuit may issue identifiers, perform light emission control of the light source, associate the identifiers with the acquired infrared light image and the acquired depth image, respectively, perform extinction control of the light source, and determine that the infrared light image and the depth image are images acquired at the same timing in a case where the identifiers match each other.

The solid-state imaging device may further include a control circuit that performs drive control of the first light receiving region, drive control of the second light receiving region, and control of the light source. The control circuit may issue an identifier, perform light emission control of the surface light source, associate the identifier with the acquired infrared light image, perform extinction control of the surface light source, perform light emission control of the point light source, associate the identifier with the acquired depth image, perform extinction control of the point light source, and determine that the infrared light image and the depth image are images acquired at the same timing in a case where the identifier associated with infrared light image and the identifier associated with the depth image match each other.

The first processing circuit may acquire an interference infrared light image in advance by emitting light from the light source onto a plane disposed at a distance of a subject, and may correct the acquired infrared light image using the interference infrared light image.

The second processing circuit may acquire an interference depth image in advance by emitting light from the light source onto a plane disposed at a distance of a subject, and may correct the acquired depth image using the interference depth image.

A pixel belonging to the first light receiving region and a pixel belonging to the second light receiving region may be disposed in the same pixel array.

According to an embodiment, an electronic apparatus includes a display, a light source, a first light receiving region, a second light receiving region, and a processing circuit. The display displays information. The light source is provided on an opposite side of a display surface of the display, and emits light in an infrared light band via the display. The first light receiving region is provided on an opposite side of the display surface of the display, and includes a pixel that receives light in a visible light band and a pixel that receives at least light in an infrared light band emitted from the light source. The second light receiving region is provided on an opposite side of the display surface of the display, and includes a pixel that receives at least light in an infrared light band emitted from the light source. The processing circuit performs authentication processing using an infrared light image acquired by a pixel belonging to the first light receiving region and a depth image acquired by a pixel belonging to the second light receiving region.

The processing circuit may determine whether a subject is an authentication target on the basis of the depth image, and may execute authentication processing using at least the infrared light image in a case where it is determined that the subject is the authentication target.

According to an embodiment, a program causes a processor to execute processing of the control circuit according to any one of the above.

According to an embodiment, a program causes a processor to execute processing of the processing circuit according to any one of the above.

The electronic apparatus described above may include at least one of a mobile terminal, a smartphone, a tablet terminal, a vehicle-mounted camera with a display, an authentication device with a display, or a monitoring camera with a display.

### BRIEF DESCRIPTION OF DRAWINGS

FIG. 1 is a diagram schematically illustrating an electronic apparatus according to an embodiment.

FIG. 2 is a diagram illustrating an example of arrangement of pixels according to an embodiment.

FIG. 3 is a block diagram schematically illustrating a solid-state imaging device according to an embodiment.

FIG. 4 is a block diagram schematically illustrating a solid-state imaging device according to an embodiment.

FIG. 5 is a flowchart illustrating processing in a solid-state imaging device according to an embodiment.

FIG. 6 is a diagram schematically illustrating an electronic apparatus according to an embodiment.

FIG. 7 is a flowchart illustrating processing in a solid-state imaging device according to an embodiment.

FIG. 8 is a diagram schematically illustrating an electronic apparatus according to an embodiment.

FIG. 9 is a diagram schematically illustrating an electronic apparatus according to an embodiment.

FIG. 10 is a diagram illustrating an example of an interference fringe according to an embodiment.

FIG. 11 is a diagram illustrating an example of an interference fringe according to an embodiment.

FIG. 12 is a diagram schematically illustrating an electronic apparatus according to an embodiment.

FIG. 13 is an external view of an electronic apparatus according to an embodiment.

FIG. 14 is an external view of an electronic apparatus according to an embodiment.

FIG. 15 is a block diagram illustrating an example of a schematic configuration of a vehicle control system.

FIG. 16 is an explanatory diagram illustrating an example of installation positions of an outside-vehicle information detecting section and an imaging section.

### MODE FOR CARRYING OUT THE INVENTION

The following is a description of embodiments of the present disclosure with reference to the drawings. The drawings are used for explanation, and the shape and size of each configuration in actual devices, the ratios of size to other configurations, and the like are not necessarily as illustrated in the drawings. Furthermore, since the drawings are illustrated in a simplified manner, configurations necessary for implementation other than those illustrated in the drawings are appropriately provided.

### First Embodiment

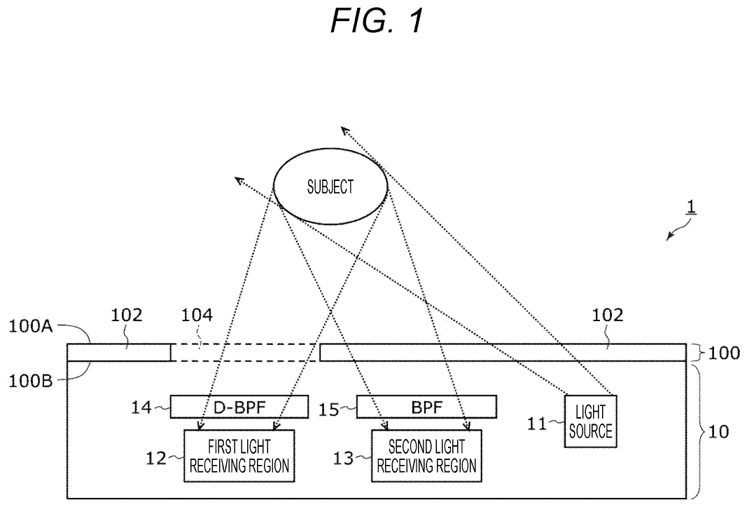

FIG. 1 is a block diagram schematically illustrating an electronic apparatus including a solid-state imaging device according to an embodiment. An electronic apparatus 1 includes a solid-state imaging device 10 and a display 100. The electronic apparatus 1 displays information on the display, captures an image by the solid-state imaging device 10 provided below the display, and executes authentication or the like based on the captured image.

The electronic apparatus 1 may be, for example, at least one of a mobile terminal, a smartphone, a tablet terminal, a vehicle-mounted camera with a display, an authentication device with a display, or a monitoring camera with a display. As an example, the electronic apparatus 1 is configured to be able to execute authentication processing on a display surface side in these apparatuses.

The display 100 is an output interface that displays information of the electronic apparatus 1. The display may be implemented by a method such as liquid crystal or organic EL. Furthermore, the display 100 may also serve as an input interface including a touch panel or the like for inputting information to the electronic apparatus 1. The display 100 includes a display section 102, and also includes a display surface 100A and a back surface 100B that is a back side of the display surface 100A.

The display section 102 is a region for displaying information. The display section 102 may be provided with an opening 104 depending on the specification of a first light receiving region to be described later. The opening 104 may be disposed, for example, as a region where no display pixel is provided. As another example, the opening 104 may be implemented by thinning out pixels in the region, or may be implemented by using a pixel having transparency to a predetermined wavelength. In this case, for the pixel that transmits, the pixel circuit may have a configuration different from that of the pixels in another display section 102.

The display surface 100A is a surface on which a user views displayed information from an outside, and may be coated with, for example, glass, a filter, or the like, or may be provided with a polarizing plate, a polarizing filter, or the like so that light output from the pixel can be appropriately viewed from the outside.

The back surface 100B is a surface opposite to the display surface 100A of the display 100, and faces the inside of the electronic apparatus 1. In the present disclosure, a region on a back surface 100B side in the electronic apparatus 1 may be referred to as a region under the display.

The solid-state imaging device 10 is a device included in the electronic apparatus 1 and is provided under the display 100. The solid-state imaging device 10 includes, for example, a light source 11, a first light receiving region 12, a second light receiving region 13, a dual-bandpass filter 14, and a bandpass filter 15.

The light source 11 is a light source used in the authentication processing, and is, for example, a light source that emits light in an infrared light band, and is provided on the back surface 100B side of the display 100, that is, under the display 100. The light source 11 includes, for example, a surface light source. A plane wave (which may not be a strict plane wave) emitted from the light source 11 irradiates a subject via the display 100, is reflected by the subject, and is incident on a light receiving element in the solid-state imaging device 10. Note that the light source 11 is not necessarily provided inside the solid-state imaging device 10, and may be provided in the electronic apparatus 1 as a module different from the solid-state imaging device 10.

The wavefront of the light emitted from the light source 11 propagates as indicated by a dotted line, and the light reflected by the subject irradiating the subject is incident on the first light receiving region 12 and the second light receiving region 13, and information for generating an image is acquired. Note that, although the distance between the subject and the electronic apparatus 1 is very short due to the space illustrated in the drawing, in practice, the distance can be sufficiently long. Therefore, the light emitted from the light source 11 illuminates substantially the front of the subject, and the reflected light can be received by the pixels belonging to the respective light receiving regions.

The first light receiving region 12 is a region provided below the display 100 and including pixels that receive light via the opening 104 of the display 100 and output a signal based on the intensity of the received light. The first light receiving region 12 includes pixels that receive light in a visible light band and pixels that receive infrared light. The pixel that receives the light in the visible light band may be, for example, a pixel that receives each of three primary colors of red (R), green (G), and blue (B), or may be a pixel that receives a complementary color system or white. The pixels that receive the light in the infrared light band are mixed and arranged in the same region (pixel array) as the pixels that receive the light in the visible light band.

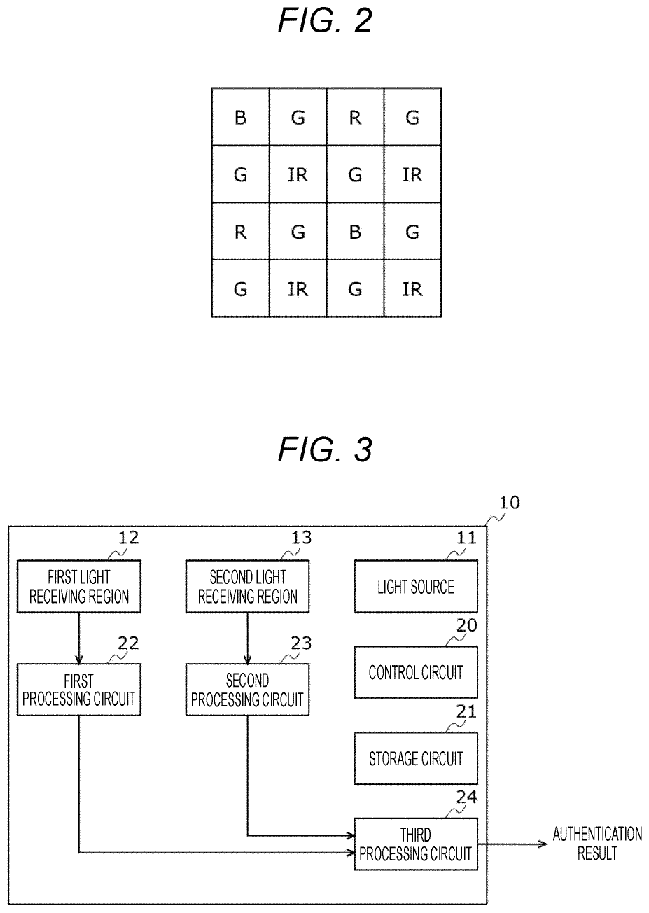

FIG. 2 is a diagram illustrating an example of a light receiving band of a pixel according to an embodiment. R represents a pixel that receives a red wavelength band, G represents a pixel that receives a green wavelength band, B represents a pixel that receives a blue wavelength band, and IR represents a pixel that receives an infrared wavelength band. As illustrated in this drawing, IR pixels may be mixed with R, G, and B pixels and provided in the same pixel array.

By providing the IR pixels as illustrated in FIG. 2, it is possible to acquire an infrared light image having a high resolution similar to that of an image in a visible light band. However, the arrangement of the pixels is not limited thereto, and may be an arrangement including complementary colors and white as described above, an arrangement corresponding to multispectrum, or a configuration including pixels or the like that can be used for various purposes such as a plasmon filter and a pixel for acquiring an image plane phase difference.

As described above, the first light receiving region 12 is arranged by mixing pixels for acquiring a visible light image and pixels for acquiring an infrared light image, and can acquire information for generating an infrared light image with high resolution. The electronic apparatus 1 can perform authentication, for example, by using the infrared light image. This biometric authentication may be, for example, biometric authentication based on information that can be acquired by infrared light, such as face authentication, iris authentication, or vein authentication of a person. Furthermore, since this authentication uses infrared light, authentication of a predetermined subject can be realized even in a dark place.

Returning to FIG. 1, the dual-bandpass filter 14 having transmission characteristics in a visible light band and an infrared light band may be provided on the light receiving side of the first light receiving region 12. The dual-bandpass filter 14 can allow light in an appropriate band to enter the first light receiving region 12.

The second light receiving region 13 is provided below the display 100, for example, and is a region in which pixels that receive light specialized for the infrared region are arranged. The second light receiving region 13 is, for example, a region including pixels for measuring time of flight (ToF). For example, the second light receiving region 13 measures a time from when the light source 11 emits light to when the reflected light from the subject returns to each pixel, and measures a distance to each position of the subject corresponding to the pixel. A depth image (distance image) can be generated on the basis of the distance.

The bandpass filter 15 having transmission characteristics in an infrared light band may be provided between the second light receiving region 13 and the display 100. When light via the bandpass filter 15 is incident on the second light receiving region 13, information regarding ToF measurement can be appropriately acquired in the second light receiving region 13.

Depending on the characteristics of the display 100, in a case where the display 100 is in a form capable of appropriately transmitting infrared light, for example, the light source 11 and the second light receiving region 13 may emit light or receive light without passing through the opening 104.

The dual-bandpass filter 14 and the bandpass filter 15 do not need to be provided alone, and may be provided integrally with a lens that condenses light from a subject to each light receiving region, for example. That is, in these filters, for example, the lens itself may have a function of a filter by appropriately selecting a substance applied to the surface of the lens or a material of the lens itself.

Next, a non-limiting example of an internal configuration for processing the information acquired as described above will be described.

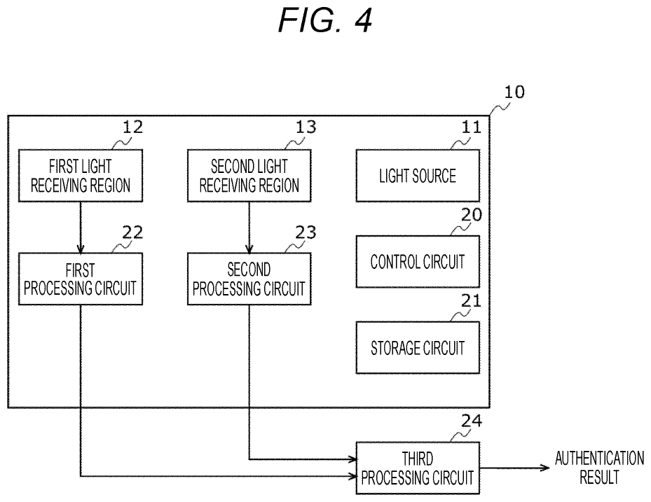

FIG. 3 is a block diagram schematically illustrating an example of the solid-state imaging device 10 according to an embodiment. The solid-state imaging device 10 includes a control circuit 20, a storage circuit 21, a first processing circuit 22, a second processing circuit 23, and a third processing circuit 24 in addition to the light source 11, the first light receiving region 12, and the second light receiving region 13. The filter and the like in FIG. 1 are not illustrated. Furthermore, although not illustrated, other configurations necessary for the operation of the solid-state imaging device 10 are appropriately provided although not illustrated.

The control circuit 20 controls the solid-state imaging device 10. For example, the control circuit 20 controls driving of pixels at the light emission timing of the light source 11 and the light reception timings of the first light receiving region 12 and the second light receiving region 13. In addition, the control circuit 20 may control the first processing circuit 22, the second processing circuit 23, and the third processing circuit 24 at an appropriate timing. That is, the control circuit 20 can control imaging control and operation related to authentication in the solid-state imaging device 10.

The storage circuit 21 is a circuit that stores data necessary for the operation of the solid-state imaging device 10 and data to be acquired. The storage circuit 21 may include at least one of a volatile memory and a nonvolatile memory, a storage, and the like.

Part or all of the processing of the control circuit or the processing circuit may be realized by information processing by software. In this case, some or all of the operations may be implemented by software, information processing by the software may be specifically implemented by using a circuit such as a processor, and a program, an execution file, or the like for executing the software may be stored in the storage circuit 21. Not only in the present embodiment, but also in the embodiments to be described later, some or all processes may be described in a program, and information processing by software may be realized using hardware resources.

The first processing circuit 22 generates at least an infrared light image from a signal acquired on the basis of the intensity of light in the first light receiving region 12. The infrared light image is an image generated from signals output from the infrared light receiving pixels belonging to the first light receiving region 12. Note that it is not excluded that the first processing circuit 22 generates the visible light image together with the infrared light image.

The second processing circuit 23 generates a depth image from a signal acquired on the basis of the light receiving timing in the second light receiving region 13. The depth image is, for example, a distance image of an area including a subject generated by a distance based on the light reception timing in the ToF pixel. The infrared light reflected by the subject is received for each pixel using the distance measurement pixel belonging to the second light receiving region 13, and the second processing circuit 23 generates the depth image on the basis of the distance acquired for each pixel.

The third processing circuit 24 executes authentication processing on the basis of the image data acquired by the first processing circuit 22 and the second processing circuit 23. For example, the third processing circuit 24 uses the depth image generated by the second processing circuit 23 to determine whether or not the subject is valid as an authentication target, and executes authentication using the infrared light image generated by the first processing circuit 22 on the basis of the result.

The third processing circuit 24 determines whether the subject is a face of a person using, for example, a depth image. The third processing circuit 24 uses the depth image to determine whether or not the acquired information of the subject has a three-dimensional structure having appropriate unevenness as a face of a person, and in a case where the acquired information of the subject is recognized as the face of the person, uses the infrared light image to execute authentication processing by an authentication method using arbitrary infrared light such as feature amount extraction of the face, an iris image, and a vein image.

The third processing circuit 24 may determine whether the subject includes symmetry of authentication by applying rule-based processing or processing using a learned model to the depth image. In the case of executing the authentication processing, the third processing circuit 24 may execute the authentication processing on the object to be authenticated by applying the rule-based processing or the processing using the learned model to the infrared light image.

Furthermore, the third processing circuit 24 can acquire information of an area where an authentication target exists in the depth image. In this case, the third processing circuit 24 may further extract an area where an object to be authenticated exists from the infrared light image, and execute authentication processing on this image area.

In the recognition processing, if necessary, the third processing circuit 24 can use information stored in the storage circuit 21 or information registered in a database or the like outside the electronic apparatus 1. These pieces of information may be appropriately encrypted and stored, or may be stored as irreversible data that cannot be returned to personal information such as a feature amount or is difficult.

As described above, according to the present embodiment, in an electronic apparatus including a display, in a case where authentication processing is performed using a light source and an imaging element provided under the display, more accurate processing can be realized using a depth image and an infrared light image. In this processing, since emission of light in the infrared band and an image of light in the infrared band are used, appropriate authentication can be performed even in a dark place. With this electronic apparatus, face authentication processing in a smartphone or the like can be realized, and a monitoring system or the like using a tablet terminal or the like can be implemented.

Note that the authentication target can be not only the face of the person but also another part of the person, for example, a vein of a hand, or can be a target that is not a person, for example, a pet or a number of a vehicle in front of or behind a vehicle-mounted device. Furthermore, the authentication may be, for example, processing of acquiring a feeling, a state, or the like of a person facing the display. For example, the electronic apparatus can acquire information such as drowsiness and emotions of a person facing a display in the vehicle-mounted device, and appropriately issue an alert or the like.

Furthermore, the electronic apparatus may be a display or the like of a conference system using a web, and in this case, authentication processing such as whether a target is properly present at a conference or whether an appropriate person is taking an examination in an examination via the web can be realized.

FIG. 4 is a diagram illustrating another example of the solid-state imaging device 10. As illustrated in this drawing, the third processing circuit 24 may be provided outside the solid-state imaging device 10. That is, the solid-state imaging device 10 may be configured to execute processing up to the image generation processing without executing the authentication processing, and output the processing to the third processing circuit 24 that executes the authentication processing included in the electronic apparatus 1.

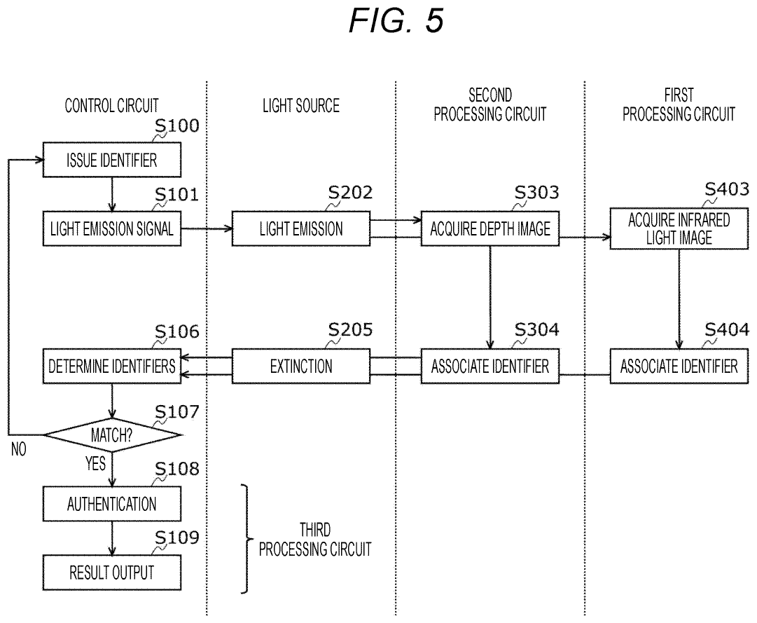

FIG. 5 is a flowchart illustrating processing of the solid-state imaging device 10 according to the embodiment.

In the execution of the authentication processing, the control circuit 20 issues an identifier (S100). This identifier is an identifier used for synchronizing captured images. The identifier only needs to be able to identify whether the image acquisition timing is the same timing or different timings, and may be, for example, information based on the timing of issuing the identifier.

After issuing the identifier, the control circuit 20 transmits to the light source 11 a light emission signal for performing light emission control of the light source 11 (S101).

The light source 11 that has received the light emission signal emits light in the infrared band to the outside of the electronic apparatus 1 via the display 100 (S202). The subject is irradiated with the infrared light emitted from the light source 11 outside the electronic apparatus 1.

The infrared light reflected by the subject enters the first light receiving region 12 and the second light receiving region 13, and is converted into an analog signal based on the intensity information in each light receiving region. The first processing circuit 22 generates an infrared light image on the basis of the signal output from the first light receiving region 12 (S403), and the second processing circuit 23 generates a depth image on the basis of the signal output from the second light receiving region 13 (S303).

Note that the second processing circuit 23 may acquire the light emission signal from the control circuit 20, and can generate the second image using the light emission timing and the light reception timing. However, the relative distance image in the subject may be acquired without acquiring the information regarding the light emission timing. For example, the time at which the reflected light is acquired in the second light receiving region 13 may be acquired for each pixel, and an image in the depth direction based on this reference point may be used as the depth image with the earliest time as a reference.

The above processing does not exclude generation of a visible light image on the basis of a signal received in the first light receiving region 12.

After acquiring the infrared light image, the first processing circuit 22 associates the identifier issued in S100 with the infrared light image (S404). Similarly, after acquiring the depth image, the second processing circuit 23 associates the identifier issued in S100 with the depth image (S304). Each of the first processing circuit 22 and the second processing circuit 23 transmits the acquired image and identifier information to the control circuit 20. For example, the control circuit 20 may transmit the identifier to the first processing circuit 22 and the second processing circuit 23.

The light source 11 emits light for a predetermined time and then turns off the light (S205). This predetermined time may be determined, for example, on the assumption that the subject is present at a predetermined distance on the basis of the time when the reflected light sufficiently reaches the first light receiving region 12 and the second light receiving region 13, and may be determined, for example, on the basis of the time when the operation of one frame in each light receiving region is completed. As another example, the first processing circuit 22 and the second processing circuit 23 may be triggered by generation of an image to perform extinction. Furthermore, the light source 11 may be extinguished by the control circuit 20 acquiring the trigger and the control circuit 20 transmitting the extinction signal to the light source 11.

The control circuit 20 that has acquired the image associated with the identifier determines whether the identifiers match (S106). By matching the identifiers, it can be determined that the received depth image and the infrared light image are images acquired at the same light emission timing of the light source 11.

Note that a time stamp can also be used as the identifier. The first processing circuit 22 and the second processing circuit 23 may associate the time stamp of the time when the image is acquired with the image as the identifier at the timing when the identifier is associated. In this case, the control circuit 20 can also determine that the identifiers match by determining whether or not the time stamp acquired by the control circuit 20 in S100 and the time stamp at the timing when the first processing circuit 22 and the second processing circuit 23 acquired the image have consistency. For example, the control circuit 20 can determine whether the identifiers match by determining whether the time stamps associated with the infrared light image and the depth image are time stamps acquired later than the time stamp acquired in S100 and time stamps acquired within a predetermined time.

In a case where the identifiers do not match (S107: NO), the control circuit 20 may repeatedly perform the processing (processing from S100) from the imaging control, or may end the processing on the assumption that identification cannot be performed.

In a case where the identifiers match (S107: YES), the control circuit 20 causes the third processing circuit 24 to execute authentication processing (S108). As described above, the third processing circuit 24 determines whether the subject is an authentication target on the basis of the depth image, and executes authentication using the infrared light image in a case where the subject is the authentication target.

Note that the third processing circuit 24 may also check whether the identifiers match. That is, the first processing circuit 22 and the second processing circuit 23 may transmit the infrared light image and the depth image together with the identifier to the third processing circuit 24. Then, the third processing circuit 24 may execute the identification processing after the determination of the identifier. As still another example, the control circuit 20 may execute the operation of the third processing circuit 24. That is, the control circuit 20 and the third processing circuit 24 may be configured by the same processing circuit.

By processing the identifier in this manner, the solid-state imaging device 10 can avoid erroneous authentication in the infrared light image by replacing the subject with a photograph or the like after the subject is set as the authentication target in the depth image.

### Second Embodiment

In the above-described embodiment, the case where there is one light source has been described. The light source 11 is, for example, a light source that emits a plane wave, and acquires an infrared light image in the first light receiving region 12 and a depth image in the second light receiving region 13 using the light source. Since the depth image can be operated at a lower resolution than the infrared light image, it is also effective to use a point light source having a higher intensity and a lower resolution than the plane wave. In the present embodiment, a light source for acquiring the depth image is separately provided.

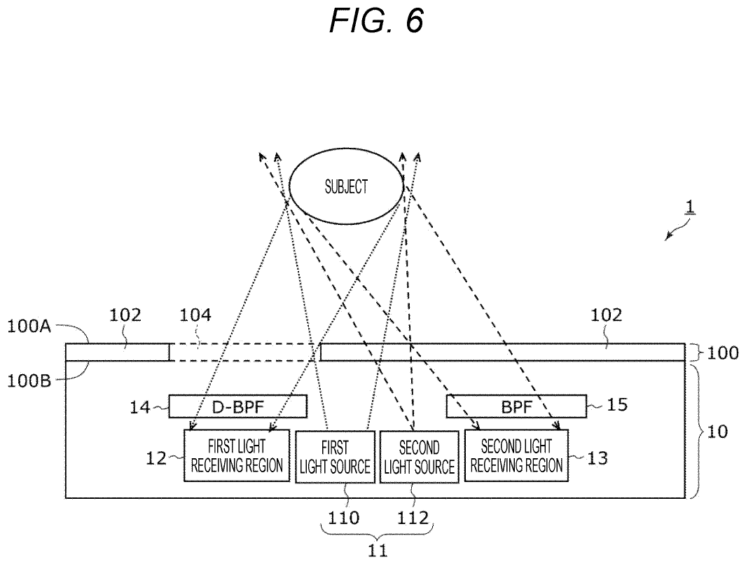

FIG. 6 is a diagram schematically illustrating an electronic apparatus 1 according to the embodiment. The electronic apparatus 1 includes a first light source 110 and a second light source 112 as a light source 11.

The first light source 110 is a light source that emits light suitable for receiving reflected light from a subject in an IR pixel included in a first light receiving region 12. The first light source 110 includes, for example, a surface light source, and emits a plane wave to the subject. The subject is irradiated with the light emitted from the first light source 110 as indicated by a dotted line in the drawing, and the reflected light is received by the first light receiving region 12.

The second light source 112 is a light source that emits light suitable for receiving reflected light from the subject in the ToF pixel or the like included in a second light receiving region 13. The second light source 112 includes, for example, a point light source having higher intensity from one point than that of the first light source 110. The light emitted from the second light source 112 is emitted to the subject as indicated by a broken line in the drawing, and the reflected light is received by the ToF pixel or the like provided in the second light receiving region 13, and a signal for forming a depth image according to the light reception timing can be acquired.

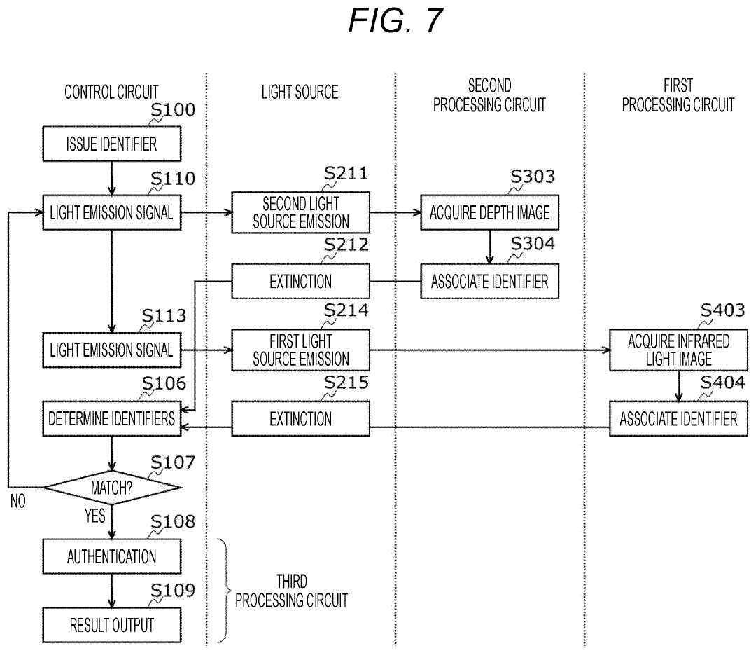

FIG. 7 is a flowchart illustrating processing of the solid-state imaging device 10 according to the embodiment. Processing denoted by the same reference signs as those in FIG. 5 are basically the same processing, and thus detailed description thereof will be omitted.

After issuing the identifier (S100), the control circuit transmits the light emission signal of the second light source 112 to the second light source 112 (S110).

The second light source 112 that has received the light emission signal emits, for example, light of a point light source (S211). The light of this point light source has intensity necessary for acquiring ToF information from a shape having no opening.

A second processing circuit 23 generates the depth image on the basis of the information of the timing at which the light is received in the second light receiving region 13 (S303), and associates the depth image with the identifier (S304).

The second light source 112 is extinguished at a predetermined timing (S212). The timing of the extinction may be a timing according to the above-described embodiment.

Next, a control circuit 20 transmits a light emission signal of the first light source 110 (S113). The transmission timing of the light emission signal may be, for example, a predetermined time after the light emission signal of the second light source 112 is transmitted, or may be after the timing at which the second light source 112 is turned off is confirmed.

The first light source 110 that has received the light emission signal emits, for example, a plane wave (S214). This plane wave has a degree of intensity necessary for acquiring an infrared light image through the opening.

A first processing circuit 22 generates an infrared light image on the basis of the intensity information received in the first light receiving region 12 (S404) and associates the infrared light image with an identifier (S404).

The first light source 110 is extinguished at a predetermined timing (S215). The timing of the extinction may also be a timing according to the above-described embodiment.

The subsequent processing is similar to that in the foregoing embodiment. By performing such processing, the authentication processing can be appropriately realized even in a case where a light source by a light receiving region is provided.

### Third Embodiment

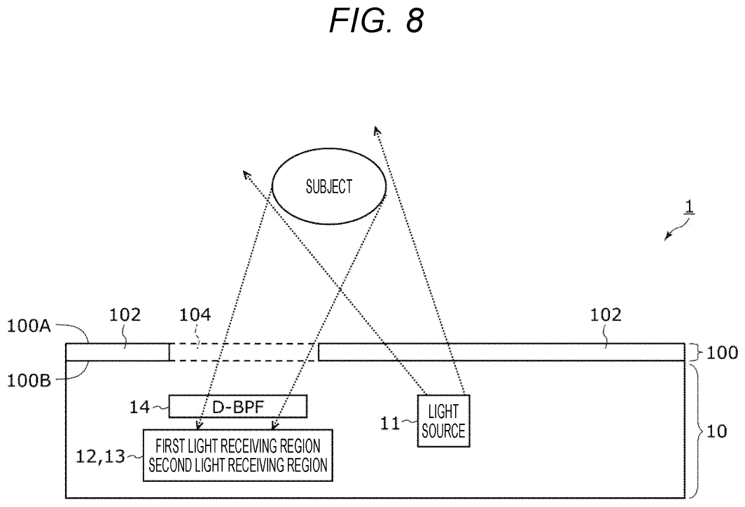

FIG. 8 is a diagram illustrating an example of arrangement of light receiving pixels according to an embodiment. A first light receiving region 12 and a second light receiving region 13 may be implemented in the same region. That is, a visible light receiving pixel that acquires information in a visible light band, an infrared light receiving pixel that acquires information in an infrared light band, and a ToF pixel that acquires ToF information from information in an infrared light band may be provided in the same pixel array.

With such an arrangement, it is possible to reduce the circuit area provided with the photoelectric conversion element as the light receiving element. Furthermore, it is possible to minimize the deviation in coordinates between the depth image and the infrared light image, and it is possible to further improve the accuracy of the processing of determining the authentication target in the depth image and the authentication processing in the infrared light image.

### Fourth Embodiment

The light emitted from the light source 11 is emitted to the outside via the display 100, and thus may interfere in the configuration of the display 100. In the present embodiment, a solid-state imaging device 10 that suppresses the influence of interference fringes that can be generated by this interference will be described.

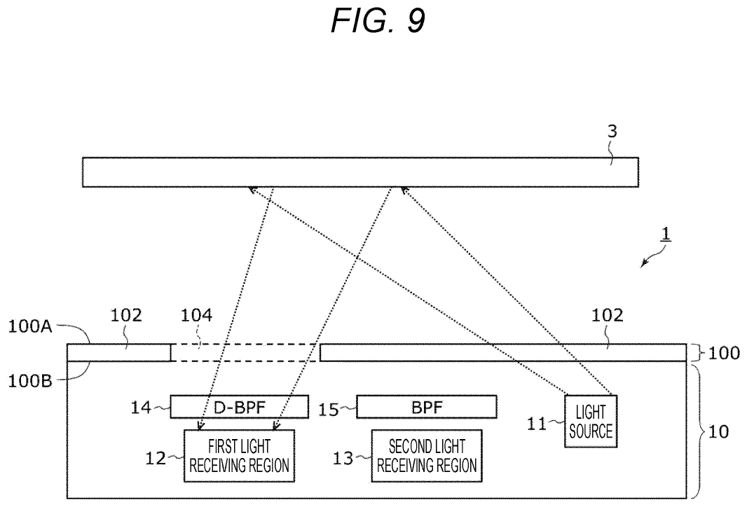

FIG. 9 is a diagram schematically illustrating an example of an electronic apparatus 1 according to an embodiment. The electronic apparatus 1 irradiates a flat surface 3 with light from a light source 11 as a previous step of executing authentication processing. The electronic apparatus 1 acquires an infrared light image generated on the basis of the reflected light on the plane in advance, and generates a pattern of interference fringes at the position of the pixel.

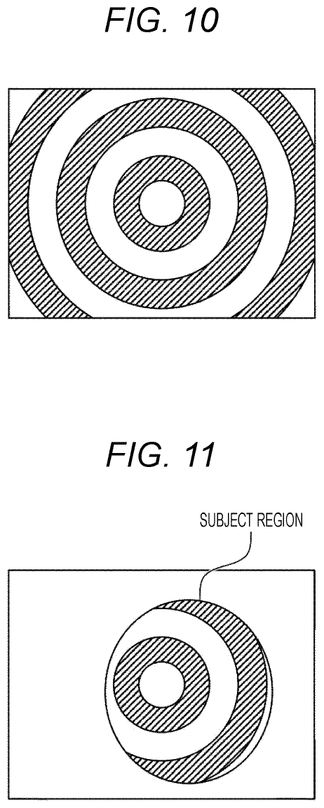

FIG. 10 is a diagram illustrating a non-limiting example of the interference fringes on a plane. A solid-state imaging device 10 may acquire an image of the interference fringes as illustrated in FIG. 10 in advance as a stage before executing the authentication processing.

For example, the solid-state imaging device 10 projects an interference fringe by irradiating a plane with the light source 11, and generates an infrared light image in which the interference fringe exists from an image received in a first light receiving region 12. This infrared light image is an infrared light image indicating a state of interference by a display 100. The solid-state imaging device 10 can correct the image at the stage of the authentication processing using the acquired infrared light image having the interference fringes.

FIG. 11 is a diagram illustrating an example of interference fringes in a subject region in an infrared light image according to an embodiment. A first processing circuit 22 can perform subtraction from the image so as to suppress the influence of the interference fringes from the region used for the authentication processing at the timing of acquiring the infrared light image. In the case of performing the subtraction, the first processing circuit 22 can perform control so as not to lower the accuracy of the information of the image acquired in the first light receiving region 12 by multiplying the image of the interference fringe by the gain and performing the subtraction.

As another example, the first processing circuit 22 may perform the mask processing based on the interference fringes on the region used for the authentication processing at the timing of acquiring the infrared light image. Similarly, the mask processing can be executed not by deleting information but by acquiring a coefficient based on the intensity of light of the interference fringe and multiplying each pixel by the coefficient so as to suppress the influence of the interference fringe.

For example, after acquiring the area of the subject for which authentication is to be executed from the depth image acquired by a second processing circuit 23, the solid-state imaging device 10 can execute the interference fringe suppression processing in the area of the subject in the first processing circuit 22.

As described above, according to the present embodiment, it is possible to reduce the influence of interference and the like caused by the display 100 in the generation of the image in the light source and the light receiving region provided under the display 100.

The removal of the interference fringes is not limited to the method described above, and a method that can appropriately remove the interference fringes on a plane acquired in advance can be used.

Furthermore, information on interference fringes in a three-dimensional figure closer to the authentication target rather than a plane may be acquired in advance. For example, in a case where the authentication processing using the face of the person is executed, the solid-state imaging device 10 may acquire the information of the interference fringes in advance using a spheroid, a gypsum image with less unevenness, or the like. Then, the authentication processing can be realized using the information of the interference fringes acquired in advance.

Note that, in the above description, the interference pattern in the infrared light image is acquired, but the present disclosure is not limited thereto. For example, the solid-state imaging device 10 may acquire the pattern of the interference fringes corresponding to the depth image in advance. This pattern can include information in consideration of a delay in arrival time of reflected light from a plane or another solid body on the display 100 up to each pixel such as ToF arranged under the display 100. Therefore, similarly in the depth image, it is possible to suppress the occurrence of the error caused by the display 100 at the authentication timing.

### Fifth Embodiment

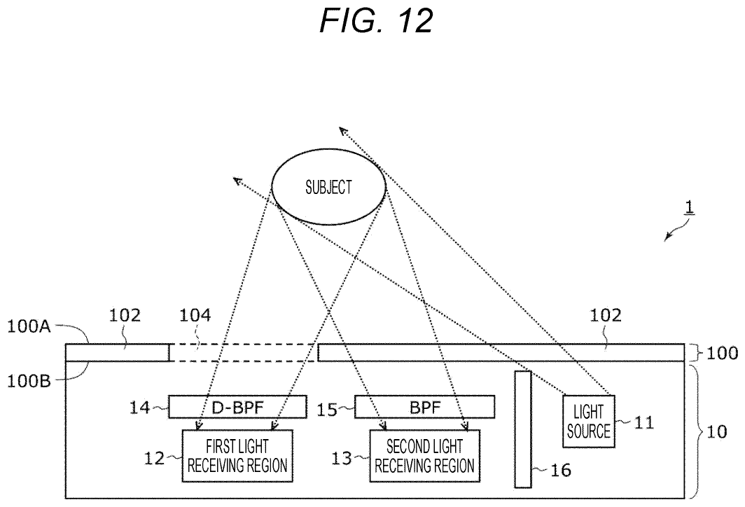

FIG. 12 is a diagram schematically illustrating an electronic apparatus 1 according to an embodiment. A solid-state imaging device 10 includes a light shielding wall 16 between a light source 11 and a light receiving region.

The light shielding wall 16 is disposed such that light emitted from the light source 11 does not directly reach each light receiving region in the electronic apparatus 1. The light shielding wall 16 may include a material that does not transmit at least a band of infrared light emitted by the light source 11.

By providing the light shielding wall 16, it is possible to realize the authentication processing in which the influence of reflection and the like in the electronic apparatus 1 and the solid-state imaging device 10 is suppressed.

Note that, in each embodiment, the first light receiving region 12 and the second light receiving region 13 are desirably disposed at close positions to reduce parallax. For example, in FIG. 6, the first light source 110 and the second light source 112 are adjacent to each other, and the light receiving region is arranged on the outer side thereof, but the present disclosure is not limited thereto. For example, the first light source 110 and the second light source 112 may be disposed outside the corresponding light receiving regions. That is, the first light source 110, the first light receiving region 12, the second light receiving region 13, and the second light source 112 may be provided in this order from the left in the drawing.

Furthermore, also in the case of FIG. 6, a light shielding wall can be provided in each. For example, the first light source 110, a first light shielding wall, the first light receiving region 12, the second light receiving region 13, a second light shielding wall, and the second light source 112 may be disposed in this order from the left in the drawing. In this case, a light shielding wall may be further disposed between the first light receiving region 12 and the second light receiving region 13.

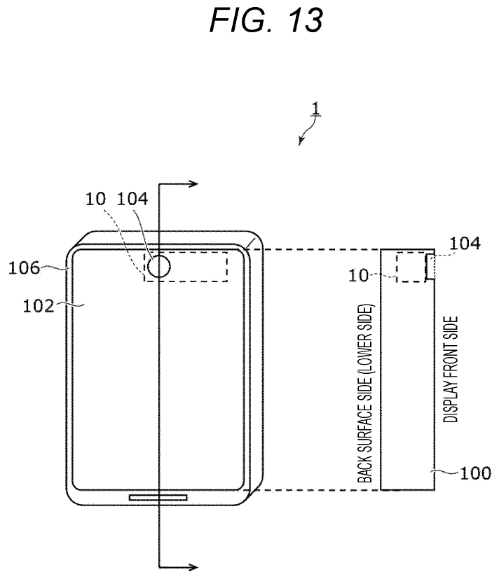

FIG. 13 is an external view of an electronic apparatus 1 according to an embodiment. The right drawing illustrates a cross-sectional view taken along the arrow in the left drawing.

The electronic apparatus 1 includes a solid-state imaging device 10 below a display 100. The display 100 is provided with an opening 104, and light necessary for image generation in the visible light band and the infrared light band enters the light receiving region through the opening 104. The opening 104 may be provided on a display surface of a display section 102 of the display 100, or may be provided in a bezel portion 106 existing at the edge of the display 100 in the electronic apparatus 1.

For example, the opening 104 may have a mode in which a light emitting pixel is not provided in the region and the region is filled with a substance that transmits light in a visible light band and light in an infrared light band for executing recognition processing.

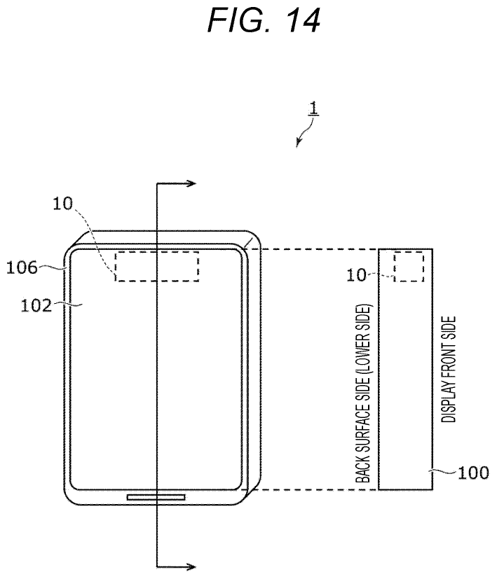

FIG. 14 is an external view of an electronic apparatus 1 according to an embodiment. Similarly to FIG. 13, the right drawing illustrates a cross-sectional view taken along an arrow in the left drawing.

As described in the above embodiment, the electronic apparatus 1 may include a solid-state imaging device 10 without including an opening 104. In this case, it is possible to have a configuration in which the light emitting pixels included in a display 100 are thinned out or an appropriate light is transmitted with the light emitting pixels or a configuration around the light emitting pixels as a configuration different from other regions. The position is not limited to the upper part of the drawing of the electronic apparatus 1, and the solid-state imaging device 10 can be disposed at an arbitrary position in the display 100.

As described above, in the electronic apparatus 1, the solid-state imaging device 10 can be appropriately disposed under the display 100.

The technology according to the present disclosure can be applied to various products. For example, the technology according to the present disclosure may also be implemented as a device mounted on any kind of moving body such as an automobile, an electric automobile, a hybrid electric automobile, a motorcycle, a bicycle, a personal mobility, an airplane, a drone, a ship, a robot, a construction machine, or an agricultural machine (tractor).

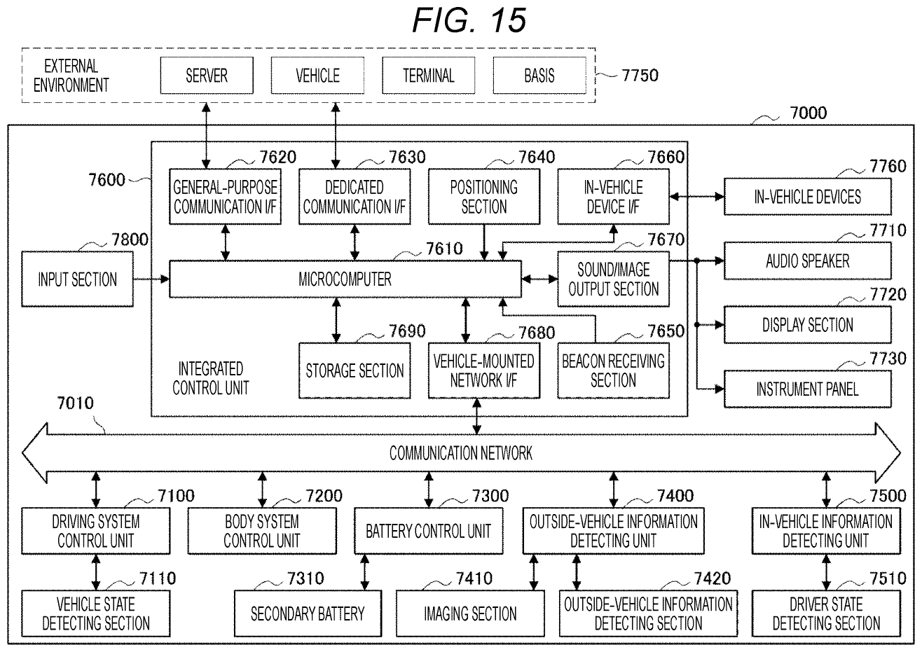

FIG. 15 is a block diagram illustrating an example of schematic configuration of a vehicle control system as an example of a vehicle control system 7000 to which the technology according to an embodiment of the present disclosure can be applied. The vehicle control system 7000 includes a plurality of electronic control units connected to each other via a communication network 7010. In the example illustrated in FIG. 15, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. In FIG. 15, a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690 are illustrated as a functional configuration of the integrated control unit 7600. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

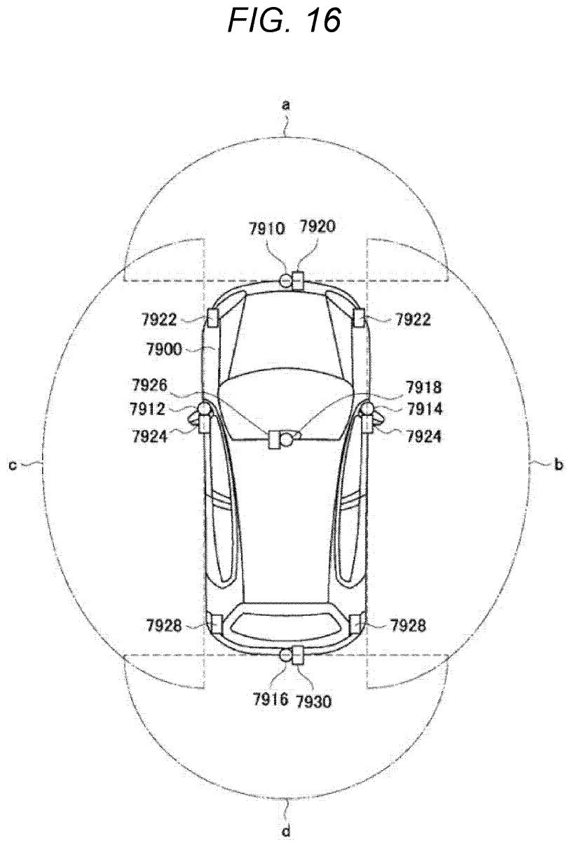

Here, FIG. 16 illustrates an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Note that FIG. 16 illustrates an example of the imaging range of each of the imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Referring back to FIG. 15, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automated driving, which makes the vehicle to travel automatedly without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 15, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Note that, in the example illustrated in FIG. 15, at least two control units connected through the communication network 7010 may be integrated as one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

Note that a computer program for realizing each function of the electronic apparatus 1 or the solid-state imaging device 10 according to the present embodiments described with reference to FIGS. 1 to 14 can be mounted on any control unit or the like. Furthermore, a computer-readable recording medium in which such a computer program is stored can be provided. The recording medium is, for example, a magnetic disk, an optical disk, a magneto-optical disk, a flash memory, or the like. Furthermore, the computer program described above may be distributed via, for example, a network without using a recording medium.

In the vehicle control system 7000 described above, the electronic apparatus 1 or the solid-state imaging device 10 according to the present embodiments described with reference to FIGS. 1 to 14 can be applied to the outside-vehicle information detecting unit 7400, the in-vehicle information detecting unit 7500, and the imaging section 7410, the outside-vehicle information detecting section 7420, or the driver state detecting section 7510 accompanying these units of the application example illustrated in FIG. 15.

Furthermore, at least some configuration elements of the electronic apparatus 1 or the solid-state imaging device 10 described with reference to FIGS. 1 to 12 may be realized in a module (for example, an integrated circuit module including one die) for the integrated control unit 7600 illustrated in FIG. 15, or may be realized by the plurality of control units of the vehicle control system 7000 illustrated in FIG. 15.

The embodiment described above may have the following forms.

(1)

A solid-state imaging device including:
a light source that is provided on an opposite side of a display surface of a display and emits light in an infrared light band via the display;
a first light receiving region that is provided on an opposite side of the display surface of the display and includes a pixel that receives light in a visible light band and a pixel that receives at least light in an infrared light band emitted from the light source; and
a second light receiving region that is provided on an opposite side of the display surface of the display and includes a pixel that receives at least light in an infrared light band emitted from the light source.
   (2)

The solid-state imaging device according to (1), further including:
a first processing circuit that generates an infrared light image based on intensity of infrared light received in the first light receiving region; and
a second processing circuit that generates a depth image based on intensity of infrared light received in the second light receiving region.
   (3)

The solid-state imaging device according to (2), further including
a third processing circuit that determines whether a subject is an authentication target on the basis of the depth image, and executes authentication processing using at least the infrared light image in a case where it is determined that the subject is the authentication target.
   (4)

The solid-state imaging device according to any one of (2) to (3), in which
the first light receiving region includes a dual-bandpass filter having transmission characteristics in two bands of a visible light band and an infrared light band between the first light receiving region and the display surface of the display.
   (5)

The solid-state imaging device according to any one of (2) to (4), in which
the second light receiving region includes a bandpass filter having transmission characteristics in an infrared light band between the second light receiving region and the display surface of the display.
   (6)

The solid-state imaging device according to any one of (2) to (5), in which
the light source includes a surface light source.
   (7)

The solid-state imaging device according to any one of (2) to (5), in which
the light source includes:
a surface light source that receives light in the first light receiving region; and
a point light source that receives light in the second light receiving region.
   (8)

The solid-state imaging device according to any one of (2) to (7), further including
a light shielding wall between the light source, and the first light receiving region and the second light receiving region on an opposite side of the display surface of the display.
   (9)

The solid-state imaging device according to (6) or (8) dependent on (6), further including
a control circuit that performs drive control of the first light receiving region, drive control of the second light receiving region, and control of the light source,
in which the control circuit issues identifiers,
performs light emission control of the light source,
associates the identifiers with the acquired infrared light image and the acquired depth image, respectively,
performs extinction control of the light source, and
determines that the infrared light image and the depth image are images acquired at the same timing in a case where the identifiers match each other.
   (10)

The solid-state imaging device according to (7) or (8) dependent on (7), further including
a control circuit that performs drive control of the first light receiving region, drive control of the second light receiving region, and control of the light source,
in which the control circuit issues an identifier,
performs light emission control of the surface light source,
associates the identifier with the acquired infrared light image,
performs extinction control of the surface light source,
performs light emission control of the point light source,
associates the identifier with the acquired depth image,
performs extinction control of the point light source, and
determines that the infrared light image and the depth image are images acquired at the same timing in a case where the identifier associated with infrared light image and the identifier associated with the depth image match each other.
   (11)

The solid-state imaging device according to any one of (2) to (10), in which
the first processing circuit acquires an interference infrared light image in advance by emitting light from the light source onto a plane disposed at a distance of a subject, and
corrects the acquired infrared light image using the interference infrared light image.
   (12)

The solid-state imaging device according to any one of (2) to (11), in which the second processing circuit acquires an interference depth image in advance by emitting light from the light source onto a plane disposed at a distance of a subject, and
corrects the acquired depth image using the interference depth image.
   (13)

The solid-state imaging device according to any one of (1) to (12), in which
a pixel belonging to the first light receiving region and a pixel belonging to the second light receiving region are disposed in the same pixel array.
   (14)

An electronic apparatus including:
a display that displays information;
a light source that is provided on an opposite side of a display surface of the display and emits light in an infrared light band via the display;
a first light receiving region that is provided on an opposite side of the display surface of the display and includes a pixel that receives light in a visible light band and a pixel that receives at least light in an infrared light band emitted from the light source;
a second light receiving region that is provided on an opposite side of the display surface of the display and includes a pixel that receives at least light in an infrared light band emitted from the light source;
a processing circuit that performs authentication processing using an infrared light image acquired by a pixel belonging to the first light receiving region and a depth image acquired by a pixel belonging to the second light receiving region.
   (15)

The electronic apparatus according to (14), in which
the processing circuit determines whether a subject is an authentication target on the basis of the depth image, and
executes authentication processing using at least the infrared light image in a case where it is determined that the subject is the authentication target.
   (16)

A program for causing a processor to execute processing of the control circuit according to (9).

(17)

A program that causes a processor to execute processing of the control circuit according to (10).

(18)

A program that causes a processor to execute processing of the processing circuit according to (14) or (15).

(19)

The electronic apparatus according to (14) or (15), in which
the electronic apparatus includes at least one of a mobile terminal, a smartphone, a tablet terminal, a vehicle-mounted camera with a display, an authentication device with a display, or a monitoring camera with a display.

Aspects of the present disclosure are not limited to the above-described embodiment, and include various conceivable modifications. The effects of the present disclosure are not limited to the above-described contents. The configuration elements in each of the embodiments may be appropriately combined and applied. That is, various additions, modifications, and partial deletions can be made without departing from the conceptual idea and gist of the present disclosure derived from the contents defined in the claims and equivalents and the like thereof.

### REFERENCE SIGNS LIST

1 Electronic apparatus
10 Solid-state imaging device
11 Light source
110 First light source
112 Second light source
12 First light receiving region
13 Second light receiving region
14 Dual-bandpass filter
15 Bandpass filter
100 Display
100A Display surface
100B Back surface
102 Display section
104 Opening
106 Bezel portion
20 Control circuit
21 Storage circuit
22 First processing circuit
23 Second processing circuit
24 Third processing circuit

1. A solid-state imaging device comprising:
a light source that is provided on an opposite side of a display surface of a display and emits light in an infrared light band via the display;
a first light receiving region that is provided on an opposite side of the display surface of the display and includes a pixel that receives light in a visible light band and a pixel that receives at least light in an infrared light band emitted from the light source; and
a second light receiving region that is provided on an opposite side of the display surface of the display and includes a pixel that receives at least light in an infrared light band emitted from the light source.

2. The solid-state imaging device according to claim 1, further comprising:
a first processing circuit that generates an infrared light image based on intensity of infrared light received in the first light receiving region; and
a second processing circuit that generates a depth image based on intensity of infrared light received in the second light receiving region.

3. The solid-state imaging device according to claim 2, further comprising
a third processing circuit that determines whether a subject is an authentication target on a basis of the depth image, and executes authentication processing using at least the infrared light image in a case where it is determined that the subject is the authentication target.

4. The solid-state imaging device according to claim 2, wherein
the first light receiving region includes a dual-bandpass filter having transmission characteristics in two bands of a visible light band and an infrared light band between the first light receiving region and the display surface of the display.

5. The solid-state imaging device according to claim 2, wherein
the second light receiving region includes a bandpass filter having transmission characteristics in an infrared light band between the second light receiving region and the display surface of the display.

6. The solid-state imaging device according to claim 2, wherein
the light source includes a surface light source.

7. The solid-state imaging device according to claim 2, wherein
the light source includes:
a surface light source that receives light in the first light receiving region; and
a point light source that receives light in the second light receiving region.

8. The solid-state imaging device according to claim 2, further comprising
a light shielding wall between the light source, and the first light receiving region and the second light receiving region on an opposite side of the display surface of the display.

9. The solid-state imaging device according to claim 6, further comprising
a control circuit that performs drive control of the first light receiving region, drive control of the second light receiving region, and control of the light source,
wherein the control circuit issues identifiers,
performs light emission control of the light source,
associates the identifiers with the acquired infrared light image and the acquired depth image, respectively,
performs extinction control of the light source, and
determines that the infrared light image and the depth image are images acquired at a same timing in a case where the identifiers match each other.

10. The solid-state imaging device according to claim 7, further comprising
a control circuit that performs drive control of the first light receiving region, drive control of the second light receiving region, and control of the light source,
wherein the control circuit issues an identifier,
performs light emission control of the surface light source,
associates the identifier with the acquired infrared light image,
performs extinction control of the surface light source,
performs light emission control of the point light source,
associates the identifier with the acquired depth image,
performs extinction control of the point light source, and
determines that the infrared light image and the depth image are images acquired at a same timing in a case where the identifier associated with infrared light image and the identifier associated with the depth image match each other.

11. The solid-state imaging device according to claim 2, wherein
the first processing circuit acquires an interference infrared light image in advance by emitting light from the light source onto a plane disposed at a distance of a subject, and
corrects the acquired infrared light image using the interference infrared light image.

12. The solid-state imaging device according to claim 2, wherein
the second processing circuit acquires an interference depth image in advance by emitting light from the light source onto a plane disposed at a distance of a subject, and
corrects the acquired depth image using the interference depth image.

13. The solid-state imaging device according to claim 1, wherein
a pixel belonging to the first light receiving region and a pixel belonging to the second light receiving region are disposed in a same pixel array.

14. An electronic apparatus comprising:
a display that displays information;
a light source that is provided on an opposite side of a display surface of the display and emits light in an infrared light band via the display;
a first light receiving region that is provided on an opposite side of the display surface of the display and includes a pixel that receives light in a visible light band and a pixel that receives at least light in an infrared light band emitted from the light source;
a second light receiving region that is provided on an opposite side of the display surface of the display and includes a pixel that receives at least light in an infrared light band emitted from the light source;
a processing circuit that performs authentication processing using an infrared light image acquired by a pixel belonging to the first light receiving region and a depth image acquired by a pixel belonging to the second light receiving region.

15. The electronic apparatus according to claim 14, wherein
the processing circuit determines whether a subject is an authentication target on a basis of the depth image, and
executes authentication processing using at least the infrared light image in a case where it is determined that the subject is the authentication target.

16. A program for causing a processor to execute processing of the control circuit according to claim 9.

17. A program for causing a processor to execute processing of the control circuit according to claim 10.

18. A program for causing a processor to execute processing of the processing circuit according to claim 14.

19. The electronic apparatus according to claim 14, wherein
the electronic apparatus includes at least one of a mobile terminal, a smartphone, a tablet terminal, a vehicle-mounted camera with a display, an authentication device with a display, or a monitoring camera with a display.
